(19) United States
(12) Patent Application Publication
(10) Pub. No.: US 2026/0243264 A1
(43) Pub. Date: Aug. 20, 2026

(54) MAGNETIC BEARING HUB AND VACUUM PUMP

(71) Applicant: Edwards Limited, Burgess Hill, Sussex (GB)

(72) Inventors: Daniel Suarez Arias, Burgess Hill, Sussex (GB); Nicolas Jonathan Grant, Burgess Hill, Sussex (GB)

(21) Appl. No.: 18/872,105

(22) PCT Filed: Jun. 1, 2023
(86) PCT No.: PCT/GB2023/051444

§ 371 Date: Dec. 5, 2024

(30) Foreign Application Priority Data
Jun. 7, 2022 (GB) 2208315.8

(51) Int. Cl. F04D 19/04; F04D 29/058; F16C 32/04

(52) U.S. Cl. CPC F04D 19/048; F04D 19/042; F04D 29/058; F16C 32/0425; F16C 2360/45

(57) ABSTRACT

Magnetic bearing hub for a vacuum pump comprising: a base element to be connected to the housing of the vacuum pump and a trunnion extending from the base element, wherein the trunnion is configured to receive a static magnetic element of the magnetic bearing, wherein the trunnion has a predetermined breaking point.

### CROSS-REFERENCE OF RELATED APPLICATION

This application is a Section 371 National Stage Application of International Application No. PCT/GB2023/051444, filed Jun. 1, 2023, and published as WO 2023/237855 A1 on Dec. 14, 2023, the content of which is hereby incorporated by reference in its entirety and which claims priority of British Application No. 2208315.8, filed Jun. 7, 2022.

### FIELD

The present invention relates to a magnetic bearing hub for vacuum pump and a vacuum pump with such a magnetic bearing hub.

### BACKGROUND

Common vacuum pump and in particular turbomolecular pumps comprise a housing having an inlet and an outlet. In the housing a rotor assembly is rotated by an electromotor and supported by a bearing or system of bearings. The rotor assembly comprises at least one rotor element interacting with at least one stator element in order to convey a gaseous medium from the inlet to the outlet. In particular, for turbomolecular pumps the rotor assembly comprises a plurality of vanes interacting with vanes of the stator. Therein, the rotor assembly is supported by usually two bearings wherein the bearings can be built either as roller bearing or magnetic bearing. In particular, the bearing towards the inlet side, i.e. the end of the rotor assembly in the direction of the inlet of the vacuum pump, may be built as permanent magnetic bearing. Therein, a rotated magnetic element is connected to the rotor, wherein a static magnetic bearing is connected to the housing. The static magnetic bearing and the rotated magnetic bearing are in close proximity and mutual repulsion in order to support the rotor shaft. Therein, the static magnetic element of the permanent magnetic bearing may be arranged at a trunnion extending into a recess of the rotor assembly such that the rotated magnetic element surrounds the static magnetic element. The trunnion is connected to the housing by webs or legs which are sometimes also referred to as “spider” or “envelope”, to provide structural stability of the trunnion and therefore the permanent magnetic bearing itself.

Due to the high rotational speed, high rotational forces exist which must be released upon crash of the vacuum pump. Thus, there is the risk that parts of the vacuum pump enter the connected vacuum apparatus and cause damage. This is in particular the case if the webs holding the trunnion break in an uncontrolled manner.

Thus, it is an object of the present invention to provide a magnetic bearing hub and a vacuum pump, wherein the damage of the vacuum apparatus connected to the vacuum pump is reduced upon crash of the vacuum pump.

The problem is solved by a magnetic bearing hub according to claim 1 and a vacuum pump according to claim 11.

The discussion above is merely provided for general background information and is not intended to be used as an aid in determining the scope of the claimed subject matter. The claimed subject matter is not limited to implementations that solve any or all disadvantages noted in the background.

### SUMMARY

In a first aspect, the present invention relates to a magnetic bearing hub for vacuum pump and in particular for turbomolecular vacuum pump. The magnetic bearing hub comprises a base element to be connected to the housing of the vacuum pump for example via two or more webs or legs. Further, the magnetic bearing hub comprises a trunnion extending from the base element, wherein the trunnion is configured to receive a static magnetic element of the magnetic bearing. In particular, the static magnetic element may comprise several permanent magnetic rings. In the assembled state, the trunnion may extend into a recess of a rotor assembly of the vacuum pump, wherein the static magnetic element is surrounded by a rotated magnetic element connected to the rotor assembly. Alternatively, the static magnetic element surrounds the rotated magnetic element. According to the present invention the trunnion has a predetermined breaking point. Thus, upon crash of the vacuum pump the trunnion breaks at the predetermined breaking point and separates from the base element. This split between the base element connected to the webs and the trunnion will protect the webs to suffer a break or damage and will help the rotor assembly to crash against the stator elements. Thereby, the rotation of the rotor assembly is braked by the friction between these components. Thus, the webs are protected to break and thereby it is avoided that big fragments of the vacuum pump are projected into the vacuum chamber of the vacuum apparatus connected to the vacuum pump. Further, by controlled breaking of components energy can be released thereby reducing the risk of breaking of additional components as well.

Preferably, the predetermined breaking points is built by a thinned wall section. Thus, the predetermined breaking point is provided by the thin wall section, wherein the thinned wall section is a section with decreased wall thickness to enable break at the position of the thinned wall section.

Preferably, the thinned wall section is built as a circumferential groove. Therein, the groove can be built at the inner surface of the trunnion. However, for ease of manufacture the groove is provided at the outer surface of the trunnion, wherein by the groove the wall thickness of the trunnion is reduced.

Preferably, the groove has a coniform or cuneiform shape or a rectangular shape. By the specific selection of the shape, stability of the predetermined breaking point can be tailored, wherein breaking of the trunnion at the position of the groove upon crash of the vacuum pump is enabled.

Preferably, the thin wall section is built by an internal bore extending into the trunnion from one end opposite to the base element until the axial end of the thinned wall section or extending axially beyond the thinned wall section. Thus, by the internal bore the material strength of the trunnion is reduced allowing to separate the trunnion from the base element.

Preferably, the thinned wall section has a reduced wall thickness of less than 80% compared to the wall thickness of the remaining trunnion. Thus, if the minimum wall thickness of the remaining trunnion is 10 mm, then it is a preferred embodiment that the thinned wall section would have a wall thickness of less than 8 mm. Preferably, the thinned wall section has a reduced wall thickness of less than 60% and most preferably a reduced wall thickness of less than 50%. By selection of the wall thickness on one hand sufficient stability of the magnetic bearing hub is maintained while on the other hand breaking of the magnetic bearing hub in the area of the thinned wall section is allowed.

Preferably, an area of the cross section of the thinned wall section is smaller than an area of the cross-section of one leg or web. In particular, the area of the cross section of the thinned wall section is between 4% and 20%, preferably between 4% and 10% and more preferably between the 5% and 8% of the area of the cross section of one leg or web.

Preferably, the predetermined breaking point is configured the break upon 10% to 50% of the maximum torque of the rotor of the vacuum pump during a crash, i.e. in a time window up to 20 ms and preferably up to 10 ms after the crash. Therein, during a crash torque values from 1 kN to 2.2 kN could be observed. However, these values depend on the rotor speed, pump type and other parameters. More preferably, the predetermined breaking point is configured to break upon 15% to 40% of the maximum torque and most preferably upon 20% to 25% of the maximum torque of the rotor of the vacuum pump. Thus, it is ensured that one of the first parts that will break is the trunnion to be separated from the spider leg or webs carrying the magnetic bearing hub and breaking preferably without damaging the webs or the spider legs.

Preferably, the predetermined breaking point is arranged between the static magnetic element and the base element. Thereby, it is ensured that the static magnetic element together with the trunnion is separated from the base element. In particular, during crash, the rotated magnetic element and the static magnetic element collapse and connect with each other. In addition, by collapsing the magnetic elements together the brittle magnetic material is confined and cannot escape into other regions of the vacuum pump and/or the vacuum apparatus. At the same time also, the trunnion split of the base element is attached to the rotor assembly by the magnetic force and cannot escape in an undesired manner. However, additionally or alternatively, also the webs may hold back any parts projected towards the inlet of the vacuum pump.

Alternatively, or additionally the predetermined breaking point is arranged directly next to the base element.

Alternatively or additionally, the predetermined breaking point is arranged between the axial end of a rotor of the vacuum pump and the base element. Thus, the predetermined breaking point is axially beyond the axial end of the rotor or at least axially beyond the rotor extension extending into the trunnion such that the trunnion surrounds the axial end of the rotor/rotor extension and separation of the trunnion is enabled.

Preferably, the predetermined breaking point is configured to not to excite the natural frequencies of the magnetic bearing and/or the envelope/spider or any other assemblies and subassemblies of the pump in the operation frequency range of the vacuum pump. Thus, in addition to determine the breaking of the magnetic bearing hub, the predetermined breaking point can be configured to provide reduced resonances in the frequency range of the vacuum pump during operation. Therein, the resonance frequencies of the magnetic bearing hub can be tailored by the shape of the predetermined breaking point, i.e. adapting the shape of the groove, introducing more than one groove or the like, or by using specific materials in order to fill one or more of these grooves or provide a weakened section as predetermined breaking point.

Preferably, the magnetic bearing hub comprises only one predetermined breaking point. Alternatively, the magnetic bearing hub comprises more than one predetermined breaking point, wherein these more than one predetermined breaking points are configured to break at different torques/radial load or the same torque/radial load applied by the rotor upon crash.

In another aspect, the present invention relates to a vacuum pump comprising a housing with an inlet and an outlet, a rotor assembly, wherein the rotor assembly is supported by at least one permanent magnetic bearing. Therein, the magnetic bearing comprises a magnetic bearing hub as described above.

Preferably, the magnetic bearing is built at the suction side of the vacuum pump, i.e. at the end of the rotor assembly arranged towards the inlet of the vacuum side.

Preferably, the magnetic bearing hub is connected to the housing via webs, wherein these webs are preferably integrally built with the housing and/or magnetic bearing hub. Thus, the webs may be integrally built with the housing, i.e. the flange of the vacuum pump, or the magnetic bearing hub. Alternatively, the webs are integrally built with the housing and the magnetic bearing hub. Thus, by building the webs and the magnetic bearing hub as one piece stability is enhanced.

Preferably, the predetermined breaking point is configured to break prior to break of the connection between the webs and the housing and/or the connection between the webs and the magnetic bearing hub.

Preferably, the webs and/or the magnetic bearing hub are made of aluminium, stainless steel or carbon fiber material. Therein, in particular the webs and/or the magnetic bearing hub are built by additive manufacturing processes such as 3D printing. Alternatively, the webs and/or the magnetic bearing hub are built by conventional machining methods.

Preferably, the webs have a predetermined breaking point preferably arranged at the connection between the webs and the housing. Therein, the predetermined breaking point of the webs is configured to break at rotational and/or radial forces larger than those necessary to break the predetermined breaking point of the magnetic bearing hub. Thus, it is ensured that first the trunnion is separated from the base element. If, for any cases, no separation occurs in the next step the webs could break at the predetermined breaking point in order to avoid damage by breaking of components of the vacuum pump in an uncontrolled manner.

The Summary is provided to introduce a selection of concepts in a simplified form that are further described in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

In the following the present invention is described in more detail with reference to the accompanying figures.

The figures show:

FIG. 1 a schematic drawing of a turbomolecular pump according to the present invention,

FIG. 2 a detailed view of the magnetic bearing hub and

FIG. 3 a top view of the vacuum pump of FIG. 1.

### DETAILED DESCRIPTION

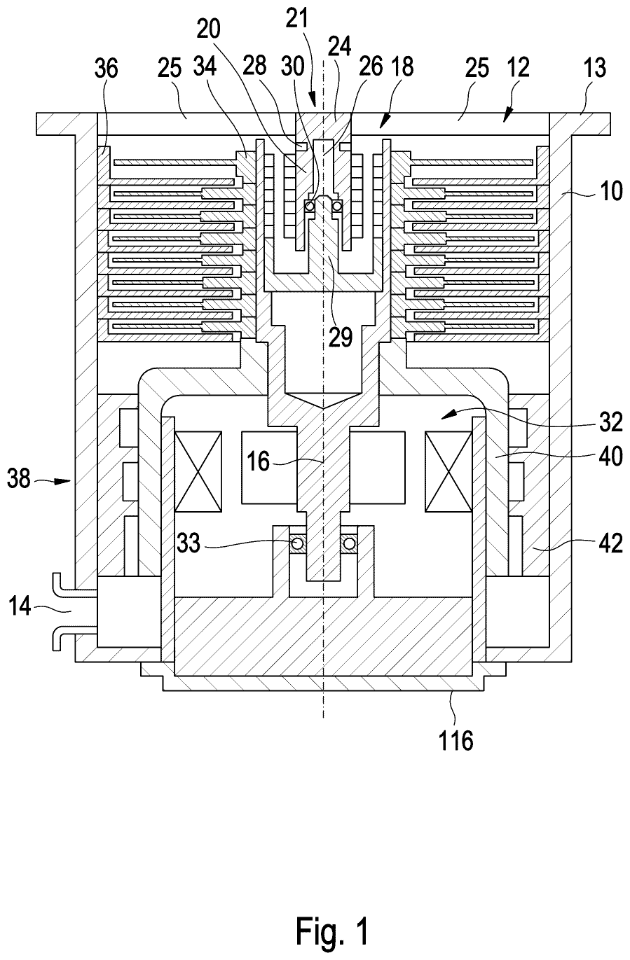

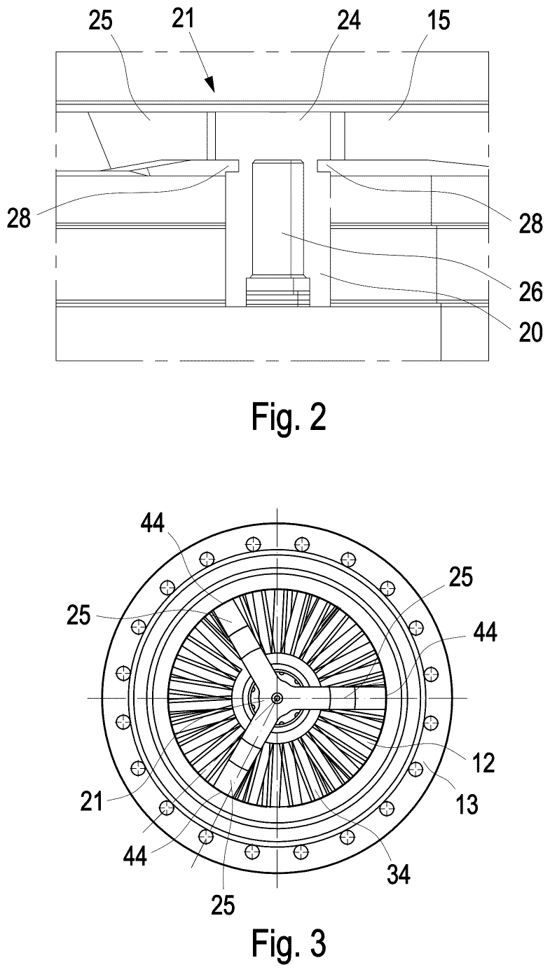

The vacuum pump of FIG. 1 comprises a housing 10 having an inlet 12 and an outlet 14. Therein, at the inlet side of the vacuum pump a flange 13 is connected. With the flange 13 the vacuum pump can be connected to a vacuum apparatus. The vacuum pump comprises a rotor assembly 16 wherein a plurality of rotor elements 34 are connected to the rotor assembly. The rotor elements 34 are built as vanes interacting with vanes of stator elements 36 connected to the housing 10. Further, the vacuum pump of FIG. 1 comprises a Hollweck stage 18 comprising a rotated cylinder 40 and a threaded stator 42, wherein the Hollweck stage 38 is arranged downstream of the turbomolecular pump stage. Instead of the Holweck stage 28 other molecular drag stages may be present such as a Siegbahn stage.

The rotor assembly 16 is rotated by an electromotor 32 and rotatably supported by a roller bearing 33 at the outlet side of the rotor assembly, i.e. at the end of the rotor assembly 16 towards the outlet 14 and opposite to the axial end of the rotor assembly 16 towards the inlet 12 of the vacuum pump. In addition, the rotor assembly is rotatably supported by the magnetic bearing 18 arranged in the inlet side of the rotor assembly 12. The magnetic bearing 18 comprises a magnetic bearing hub 21. The magnetic bearing hub 21 is connected to the housing 10 and in particular to the flange 13 of the vacuum pump via webs 25 or legs. The magnetic bearing hub 21 comprises a base element 24 connected to the webs 25. Further, the magnetic bearing hub 21 comprises a trunnion 20 extending from the base element 24 into a recess of the rotor assembly 16. To the trunnion 20 a static magnetic element of the magnet bearing 18 is connected surrounded by a rotated magnetic element connected to the rotor assembly 16. Therein, the static magnetic element and the rotated magnetic element may comprise a plurality of magnetic rings in mutual repulsion to each other in order to support the rotor assembly. The trunnion 20 of the magnetic bearing hub 21 may comprise a bore 26 extending into the trunnion from an end opposite to the base element 24. Into this bore 26 an axial extension 29 of the rotor assembly 16 is extending. Further, emergency bearings 30 may be arranged in this bore 26 surrounding the axial extension 29 of the rotor assembly 16.

In accordance, to the present invention the magnetic bearing hub 21 comprises a predetermined breaking point built as groove 28 in the example of FIG. 1. Therein, the groove 28 can be a recessed part in order to provide a thinned wall section in the area of the groove 28. Alternatively, the groove 28 may be filled with a weaker material such as plastic, a softer metal to allow the trunnion 20 to be separated from the base element 24 upon crash of the rotor assembly 16 into the stator elements 36 of the vacuum pump. In addition, the bore 26 extends axially until the end of the predetermined breaking point, i.e. the groove 28, to further reduce the material thickness at the predetermined breaking point and allow breaking of the trunnion and separating of the trunnion 20 from the base element 24.

Hence, upon crash of the vacuum pump due to the predetermined breaking point of the magnetic bearing hub 21, the trunnion 20 breaks off and separates from the base element 24 without damaging or breaking the webs 25. At the same time, due to the magnetic forces between the static magnetic element and the rotated magnetic element of the magnetic bearing the loosed trunnion 20 is collapsing with the rotor assembly 16 due to the magnetic forces and thus does not create a part that can be projected into unwanted areas, i.e. the vacuum apparatus connected to the vacuum pump.

Therein, the predetermined breaking built as groove 28 in the example of the figures is arranged directly next to the base element 24 and above the static magnetic element of the magnetic bearing 18. In addition, the predetermined breaking point is arranged axially beyond the axial extension 29 of the rotor assembly 16 to allow complete separation and enable contact between the rotor elements 34 and the stator elements 36 as well as the rotated cylinder 40 and the threaded stator 42 to break the rotation of the rotor assembly 16 as fast as possible.

In addition, the webs 25 may have predetermined breaking points at the connection point 44 between webs 25 and the flange 13 or between the webs 25 and the base element 24 of the magnetic bearing hub 21, such that the webs 25 break in a controlled manner if, for any case, a controlled separation of the trunnion from the base element 24 is not possible.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are described as example forms of implementing the claims.

1. A magnetic bearing hub for a vacuum pump comprising:
a base element to be connected to the housing of the vacuum pump and
a trunnion extending from the base element, wherein the trunnion is configured to receive a static magnetic element of the magnetic bearing,
wherein the trunnion has a predetermined breaking point.

2. The magnetic bearing hub according to claim 1, wherein the predetermined breaking point is built by a thinned wall section.

3. The magnetic bearing hub according to claim 2, wherein the thinned wall section is built as a circumferential groove.

4. The magnetic bearing hub according to claim 3, wherein groove has a cuneiform shape or a rectangular shape.

5. The magnetic bearing hub according to claim 2, wherein thinned wall section is built by an internal bore extending into the trunnion from one end opposite to the base element until end of or beyond the thinned wall section.

6. The magnetic bearing hub according to claim 2, wherein the thinned wall section has a reduced wall thickness of less than 80% compared to the wall thickness of the remaining trunnion.

7. The magnetic bearing hub according to claim 1, wherein the pre-determined breaking point is configured to break upon 10% to 50% of the maximum torque of a rotor of the vacuum pump.

8. The magnetic bearing hub according to claim 1, wherein the pre-determined breaking point is arranged between the static magnetic element and the base element; and/or
wherein the predetermined breaking point is arranged directly next to the base element; and/or
wherein the predetermined breaking point is arranged between the end of a rotor of the vacuum pump and the base element.

9. The magnetic bearing hub according to claim 1, wherein the pre-determined breaking point is configured to suppress natural frequencies of the magnetic bearing hub and/or a webs of the vacuum pump in the operation frequency range of the vacuum pump.

10. A vacuum pump comprising a housing with an inlet and an outlet, and a rotor assembly, wherein the rotor assembly is supported by at least one magnetic bearing, wherein the magnetic bearing comprises a magnetic bearing hub according to claim 1.

11. The vacuum pump according to claim 10, wherein the magnetic bearing hub is connected to the housing via webs and wherein the webs are preferably integrally built with the housing and/or the magnetic bearing hub.

12. The vacuum pump according to claim 11, wherein the predetermined breaking point is configured to break prior to break of the connection between the webs and the housing.

13. The vacuum pump according to claim 11, wherein an area of a cross section of the thinned wall section is smaller than an area of a cross-section of one web.

14. The vacuum pump according to claim 11, wherein the webs and/or the magnetic bearing hub are made of aluminum, stainless steel or carbon fiber material, preferably by additive manufacturing.

15. The vacuum pump according to claim 11, wherein the webs have a predetermined breaking point, preferably arranged at the connection between the webs and the housing.

16. The magnetic bearing hub according to claim 6, wherein the reduced wall thickness of the thinned wall section is less than 60% compared to the wall thickness of the remaining trunnion.

17. The magnetic bearing hub according to claim 16, wherein the reduced wall thickness of the thinned wall section is less than 50% compared to the wall thickness of the remaining trunnion.

18. The magnetic bearing hub according to claim 7, wherein the pre-determined breaking point is configured to break upon 15% to 40% of the maximum torque of the rotor of the vacuum pump.

19. The magnetic bearing hub according to claim 18, wherein the pre-determined breaking point is configured to break upon 20% to 25% of the maximum torque of the rotor of the vacuum pump.

20. The vacuum pump according to claim 13, wherein the area of the cross section of the thinned wall section is between 4% and 20% of the area of the cross section of the one web.
